(19) United States
(12) Patent Application Publication
(10) Pub. No.: US 2026/0089140 A1
(43) Pub. Date: Mar. 26, 2026

(54) REDACTION OF DIGITAL DOCUMENTS UTILIZING MAXIMUM LIKELIHOOD GAUSSIAN NOISE ADDITION AND PROCESS OF REVERSE ESTIMATION

(71) Applicant: Bank of America Corporation, Charlotte, NC (US)

(72) Inventors: Sivashalini Sivajothi, TamilNadu (IN); Maneesh Kumar Sethia, Telangana (IN); Saurabh Arora, Gurugram (IN); Gowri Sundar Suriyanarayanan, Chennai (IN); Abhijit Behera, Hyderabad (IN)

(21) Appl. No.: 18/894,168

(22) Filed: Sep. 24, 2024

(51) Int. Cl. H04L 9/40; G06F 21/62; G06V 30/41

(52) U.S. Cl. CPC H04L 63/0428; G06F 21/6245; G06V 30/41

(57) ABSTRACT

This disclosure relates to protecting sensitive information in electronic images of documents by removing or obscuring the sensitive information in a reversible manner. A system and process may receive a digital image, identify the sensitive information in the image, and add Gaussian noise to a document in a unique way that obscures the sensitive information. For security, the computing platform ensures that noisy data added to a document is distinct from noise patterns that have been added to other digital files. Further aspects include a system and process for reverse estimation to restore a document with added noise to its original form. The addition and removal of noise may be based on maximum likelihood estimation and may utilize models trained on prior sets of noisy data to determine uniqueness of the noisy data.

### BACKGROUND

The electronic transmission of documents is at risk of cybersecurity threats that could expose a person's confidential and sensitive financial information. In today's digital landscape, protecting sensitive information has become a paramount concern for organizations of all sizes and industries. For example, real-estate documents, bank documents, know-your-client (KYC) documents, and check documents that have been digitized include personally identifiable information that needs to be protected. It is essential to understand the potential risks associated with data extraction and take proactive measures to safeguard our personally identifiable information, the disclosure of which compromises privacy. Personal information can be used by individuals or organizations for various purposes without consent, which can lead to unwanted solicitations and financial repercussions. Cybercriminals may gain access to bank accounts, credit cards, or other financial information, enabling them to make unauthorized transactions. Given the risks of exposing sensitive customer information, a need exists to remove or obscure such information from electronic documents, for example, when being transmitted through unsecure channels.

### SUMMARY

The following summary is intended to provide a simplified understanding of some aspects of the disclosure. It is not a comprehensive overview, nor does it aim to identify key elements or delineate the scope of the disclosure. Instead, it serves as a brief introduction to the concepts discussed in the subsequent description.

Aspects of the disclosure provide effective, efficient, scalable, and convenient technical solutions that address and overcome the technical problems associated with conventional encryption methods for securing information in digital documents.

In accordance with some aspects, a computing platform comprising at least one processor, a communication interface, and memory that has stored therein computer-readable instructions may receive a digital image, identify a starting point in the digital image where noise may be added, and generate a starting noise variance corresponding to the starting point. Using maximum likelihood estimation, the computing platform may further identify a new noisy data set estimated to be unique. The new noisy data set may comprise a plurality of additional points in the digital image and a plurality of additional noise variances corresponding to the plurality of additional points, respectively, wherein the plurality of additional points are ordered in a sequence relative to the starting point. The computing platform may then add the new noisy data set to the digital image to generate a Gaussian noisy image. The Gaussian noisy image may then be secure when transmitted through an unsecured network. The plurality of additional noise variances has a Gaussian distribution.

In one or more instances, the computing platform may further detect one or more regions in the digital image comprising sensitive data and select the plurality of additional points in the digital image from within the one or more regions. Alternatively, the plurality of additional points may include every point in the digital image.

In one or more instances, the computing platform may receive feedback from a predictive noise model indicating uniqueness, within a plurality of prior noisy data sets, of the starting point and the starting noise variance, wherein the identifying of the starting point and the generating of the starting noise variance is based on the feedback.

In one or more instances, the computing platform may test the new noisy data set against a plurality of prior noisy data sets and verify, based on the testing, that the new noisy data set is unique amongst the plurality of prior noisy data sets. The addition of the new noisy data set to the digital image may be based on verification.

In one or more instances, the computing platform may calculate a statistical distance between the new noisy data set and the plurality of prior noisy data sets. The verifying that the new noisy data set is unique may be based on the statistical distance being greater than a predetermined threshold.

In one or more instances, based on the verifying, the computing platform may store the new noisy data set in a database as one of the plurality of prior noisy data sets.

In one or more instances, for each additional data point of the plurality of additional points, the plurality of prior noisy data sets may comprise a plurality of noise variances having a Gaussian distribution, wherein each noise variance of the plurality of noise variances is comprised in a different one of the plurality of prior noisy data sets.

In one or more instances, the testing of the new noisy data set against the plurality of prior noisy data sets may include evaluating the new noisy data set with a machine-learning model trained with the plurality of prior noisy data sets.

Some aspects of the disclosure are directed to the reverse process of removing Gaussian noise from an image to reverse the redaction of the image. According to one or more instances, a computing platform comprising at least one processor, a communication interface, and memory-storing computer-readable instructions may receive a Gaussian noisy image, receive an indication of a first point, and a first noise variance added to the Gaussian noisy image. The indication may be received from a database that stored this information from when the Gaussian noisy image was created. The computer platform may identify, using maximum likelihood estimation, a sequence of additional points and respective additional noise variances estimated to be unique and possibly the same as a noisy data set that was added to the Gaussian noisy image.

In one or more instances, the computing platform may test that the sequence of additional points and respective additional noise match to feedback from the predictive noise discriminator. Based on a match, the computing platform may subtract the unique noisy data set from the digital image to recover the original image.

These features, along with many others, are discussed in greater detail below.

### BRIEF DESCRIPTION OF THE DRAWINGS

The present disclosure is illustrated by way of example and not limited to the accompanying figures in which like reference numerals indicate similar elements and in which:

FIGS. 1A-1B depict an illustrative computing environment for implementing the redaction of sensitive document information in accordance with one or more example embodiments;

FIG. 2 depicts an illustrative method for redacting sensitive data in a document in accordance with one or more example embodiments;

FIG. 3 depicts illustrative digital documents and multiple stages of redaction in accordance with one or more example embodiments;

FIG. 4 depicts an illustrative method for identifying unique patterns of noise variance in accordance with one or more example embodiments;

FIG. 5 depicts an illustrative method for removing Gaussian noise variances from a redacted digital document in accordance with one or more example embodiments; and

FIG. 6 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof and are shown by way of illustration of various embodiments in which aspects of the disclosure may be practiced. In some instances, other embodiments may be utilized, and structural and functional modifications may be made without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Some aspects of the disclosure relate to protecting sensitive information in electronic images of documents—such as bank documents, know-your-client (KYC) documents, and check documents—by removing or obscuring such information in a reversible manner. In some examples, certain information is obscured while the documents are transmitted through unsecured channels or stored in unsecured storage, and a reverse process is applied to restore the original image of the document once the document is returned to a secure environment.

Aspects include a system and process having three unique components—a synthetic noise coupler, a predictive noise discriminator, and a noise addition variance collector—to add Gaussian noise to a document in a unique way. The system and process ensure that noisy data added to a document is unique in that it is not the same as the noise patterns that have been added to other digital files. In this way, the data is secured in multiple ways. First, the noise that is added prevents the sensitive data from being viewed by unauthorized receivers of the data. Second, since the noise is unique, it is not susceptible to attacks based on knowledge of a noise pattern in another document that has been obscured.

Further aspects include a system and process for reverse estimation to restore a document with added noise to its original form. Reverse estimation may utilize the predictive noise discriminator, the noise addition variance collector, and a Gaussian denoiser. The reverse process utilizes the predictive noise discriminator and the noise addition variance collector to provide information about the noise added to a document, and the Gaussian denoiser removes the noise to return the image to its original form or close to the original form.

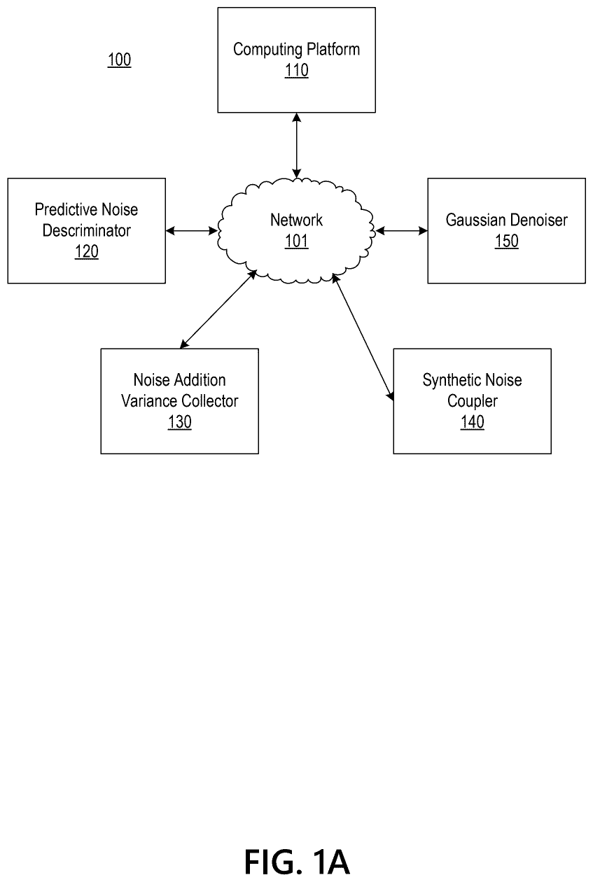

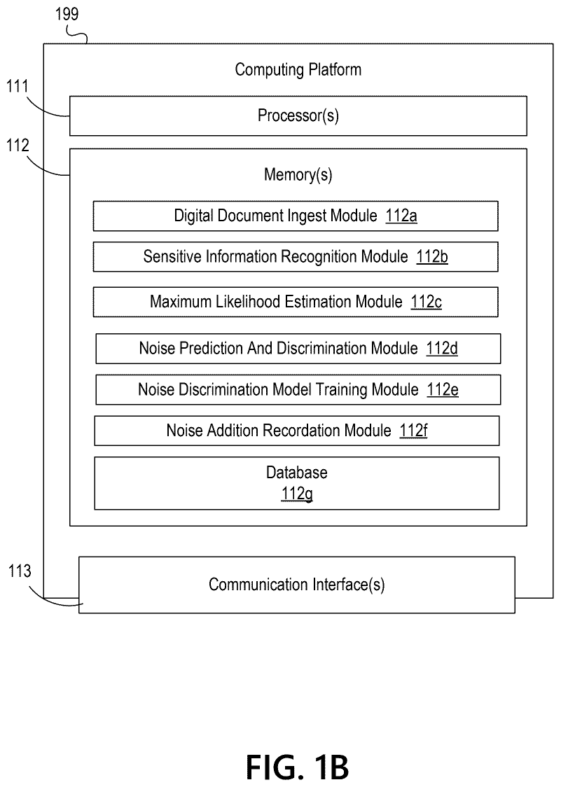

FIGS. 1A-1B depict an illustrative computing environment and devices for implementing the redaction of sensitive document information utilizing, for example, maximum likelihood Gaussian noise addition and a process of reverse estimation. Referring to FIG. 1A, computing environment 100 may include one or more computing devices and/or other computing systems. For example, computing environment 100 may include a computing platform 110, a predictive noise discriminator computing device 120, a noise addition variance collector computing device 130, a synthetic noise coupler computing device 140, and a Gaussian denoiser computing device 150. Each of devices 110, 120, 130, and 140 may be communicatively coupled through one or more networks 101.

Although four computing devices are shown, any number of systems or devices may be used without departing from the invention.

Computing platform 110 may be configured to obtain or process images of documents that include sensitive data. For example, computing platform 110 may process bank documents, know-your-client (KYC) documents, and check documents that have been digitized and include personally identifiable information such as bank account numbers, names, social security numbers, etc., that needs to be protected. In one example, computing platform 110 may be a cell phone or other personal electronic device with a camera and a banking application used to capture images of a bank check and electronically transmit the image of the check through network 101 for depositing the check in a bank. In other examples, computing platform 110 may be a kiosk, personal computer, scanner, etc.

The synthetic noise coupler computing device 140 may use a process, such as maximum likelihood estimation, to identify noise variance parameters (e.g., a percentage of noise to add or subtract) for a set of points (e.g., pixels or group of pixels) that are most likely to be unique from patterns of noise variance parameters added to other prior documents.

The predictive noise discriminator computing device 120 may be trained on multiple prior sets of noise variance parameters to detect whether a new set of noise variance parameters is unique. The predictive noise discriminator may provide feedback to the synthetic noise coupler in verifying the uniqueness of the newly identified noise variance added to one or more points in a document. Once verified, synthetic noise coupler computing device 140 may add the verified noise variance to the digital document

The noise addition variance collector 130 may monitor the addition of noise variances to the document and store the noise variance parameters in a storage device or later use in denoising the image.

The reverse process utilizes the predictive noise discriminator computing device 120 and the noise addition variance collector 130 to provide information about the noise added to a document, including a starting point at which noise variance was first added and the pattern of adding noise variances to subsequent points in the document. The Gaussian denoiser 150 may remove the noise by following the same pattern to return the image to its original form or close to its original form. The process of redacting sensitive information and the reverse process may operate in secure environments, while the redacted document may be transmitted and stored in unsecure environments.

Each of computing devices 110, 120, 130, 140, and 150 may be or include one or more computer components (e.g., servers, server blades, memory, processors, or the like) and may each include systems, applications, and the like, for processing call data. Accordingly, each of computing devices 110, 120, 130, 140, and 150 may be a plurality of computing devices in a system for processing call data and may communicate with each other via machine-to-machine communication or data exchange to process the call data.

As mentioned above, computing environment 100 may also include one or more networks, which may interconnect one or more computing platforms 110, 120, 130, 140, and 150. For example, computing environment 100 may include network 101, which may be a public or private network. Network 101 may include one or more sub-networks (e.g., Local Area Networks (LANs), Wide Area Networks (WANs), or the like). Network 101 may interconnect one or more computing devices associated with the organization. For example, computing platforms 110, 120, 130, 140, and/or 150 may be connected via network 101.

FIG. 1B illustrates an example computing platform 199 that may be used to implement each or all of computing platforms 110, 120, 130, 140, and/or 150. Computing platform 199 may include one or more processors 111, memory 112, and communication interface 113. A data bus may interconnect processor(s) 111, memory 112, and communication interface 113. Communication interface 113 may be a network interface configured to support communication between (e.g., network 101 or the like). Memory 112 may include one or more program modules having instructions that, when executed by processor(s) 111, cause a computing platform 110, predictive noise discriminator computing device 120, noise addition variance collector computing device 130, synthetic noise coupler computing device 140, or Gaussian denoiser computing device 150 to perform one or more functions described herein and/or one or more databases that may store and/or otherwise maintain information which may be used by such program modules and/or processor(s) 111. In some instances, the one or more program modules and/or databases may be stored by and/or maintained in different memory units of computing platform 199 and/or by other computing devices that may form and/or otherwise make up computing platform 199.

For example, memory 112 may have, store, and/or include a digital document ingest module 112a that may store instructions and/or data that may cause or enable the computing platforms 110, 120, 130, 140, and/or 150 to receive digital documents as further described below from other computing platforms. Computing platform 199 may further have, store, and/or include sensitive information recognition module 112b. Sensitive information recognition module 112b may store instructions and/or data that may cause or enable the computing platform 199 to recognize regions in a digital document comprising sensitive information that needs to be redacted or obscured, as further discussed below.

Computing platform 199 may further have, store, and/or include a maximum likelihood estimation module 112c that may use various data estimation algorithms to identify data that has a maximum likelihood of matching a statistical distribution of prior data and/or identify data that has a maximum likelihood of being distinct from a statistical distribution of prior data. Maximum likelihood estimation module 112c may be used by synthetic noise coupler 140 for identifying unique noise variances and/or by Gaussian denoiser or estimating

Computing platform 199 may further have, store, and/or include a noise prediction and discrimination module 112d that may use various data matching algorithms, entropy analysis, and machine learning algorithms for detecting whether a sequence of noise variance may be unique from a plurality of prior noisy data sets. Computing platform 199 may further have, store, and/or include a noise discrimination model training module 112e that may train a model, such as a machine learning or neural network model, with a plurality of noisy data sets to detect whether a test noisy data set is unique.

Computing platform 199 may further have, store, and/or include a noise addition recordation module 112f that may collect noisy data sets being applied to digital documents and store the sets, for example, in a database 112g. Database 112g may store data related to noise variances added to electronic documents, including starting points for adding noise variances to documents and sequences of noise variances and/or other data to perform the functions of the computing platforms 110, 120, 130, 140, and/or 150.

Computing platforms 110, 120, 130, 140, and/or 150 may each include some or all of the components included in computing platform 199, as illustrated and described with respect to FIG. 1B.

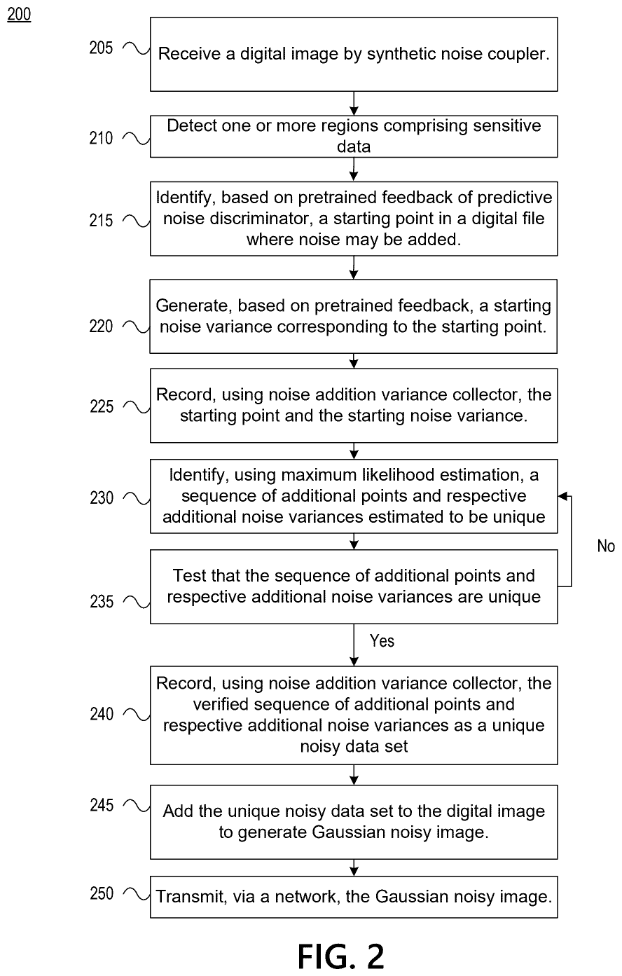

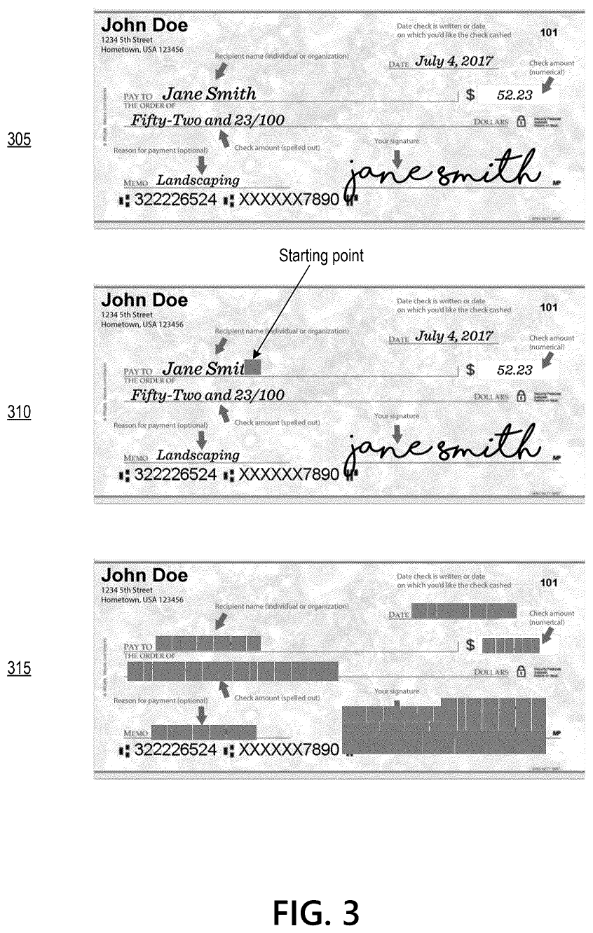

FIG. 2 depicts an illustrative process 200 for redacting sensitive data in a document in a unique and secure way by utilizing maximum likelihood Gaussian noise addition. FIG. 3 depicts an example document at various stages of processing according to the steps of FIG. 2. Process 200 may start at step 205, in which synthetic noise coupler 140 receives a digital document (e.g., a digital image) containing sensitive information for redaction. For example, synthetic noise coupler 140 may receive a banking document such as a check from computing platform 110 (e.g., a secure banking server) via a secure network connection.

At step 210, synthetic noise coupler 140 may identify one or more regions within the digital document that contain sensitive information to be redacted. For example, if the document is a check, synthetic noise coupler 140 may identify regions to redact that include the account holder's signature, the recipient's name, the date the check was written, the check amount, and any comments in the notes section as indicated in document 305 illustrated in FIG. 3. Synthetic noise coupler 140 may further identify different levels of security associated with each region to redact, with higher levels of security requiring increased levels of redaction. In some examples, the entire digital document may be identified for redaction.

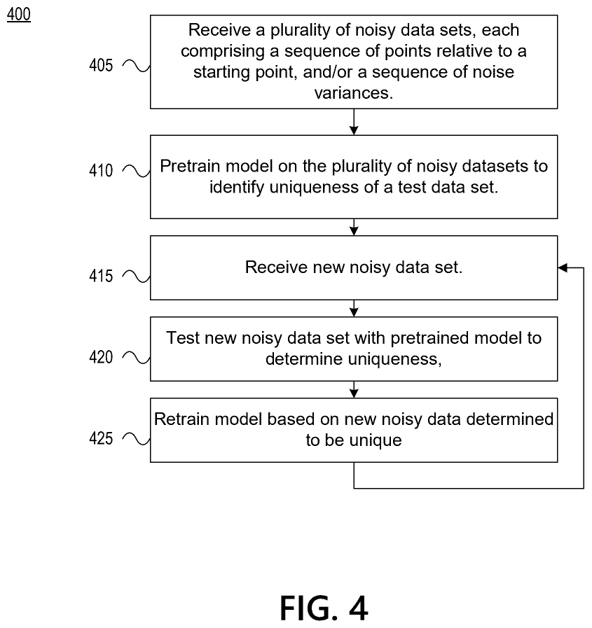

Synthetic noise coupler 140 may communicate with predictive noise discriminator 120 (e.g., via network 101) to receive feedback to identify a starting point in the digital document in step 215 and to identify a starting noise variance in step 220 to add to the starting point. As further described below with respect to FIG. 4, a predictive noise discriminator may be pre-trained with a plurality of noisy data added to other digital documents, and based on that training, provide feedback to synthetic noise coupler 140 on a starting point (e.g., a starting pixel or region of pixels) for adding a noise variance (e.g., Gaussian noise). The feedback may be based on the uniqueness of the starting point and/or a starting noise variance for the starting point compared to starting points and/or starting noise variances in other previous documents in which information has been obscured. In other examples, feedback may be based on making the overall pattern of noise variances added to the document unique from noise patterns in other previous documents in which information has been obscured so that knowledge about noise added to one document cannot be used to reveal sensitive data in another document. In some examples, the starting points across multiple documents may have a Gaussian distribution. In some examples, the starting noise variances across multiple documents may have a Gaussian distribution.

In some examples, the feedback may include a starting point and/or starting noise variance for synthetic noise coupler 140 to use in the digital document. In other examples, synthetic noise coupler 140 may select a starting point and/or starting noise variance randomly, and the feedback from predictive noise discriminator 120 may confirm that the selected point and/or noise variance are unique. In such examples, step 220 may be performed prior to step 215. In other examples, steps 215 and step 220 may be done iteratively. For example, synthetic noise coupler 140 may select a starting point and/or noise variance (e.g., randomly) and may adjust the starting point position and/or noise variance level based on the feedback from predictive noise discriminator 120.

Uniqueness may be measured based on the starting point or noise variance fitting along a Gaussian distribution curve or other predetermined distribution curve of starting points or noise variances in prior encoded documents. The selection of the starting point may be limited to the one or more regions within the digital document identified in step 210. An example starting point and starting noise variance is illustrated in modified document 310 illustrated in FIG. 3.

At step 225, noise addition variance collector 130 may receive the starting point and/or the starting noise variance from synthetic noise coupler 140 and store the received information in a database. The stored starting point and/or starting noise variance may later be used to remove the noise and restore the document to its original form.

At step 230, synthetic noise coupler 140 may use maximum likelihood estimation or another estimation technique to identify a sequence of additional points and respective additional noise variances estimated to be unique. For example, based on the selected starting point and/or starting noise variance for the starting point, synthetic noise coupler 140 may estimate a sequence of points (e.g., pixels or regions of pixels) and a sequence of noise variances (e.g., Gaussian noise variances) to add to the sequence of pixels, respectively, estimated to have a maximum likelihood of being unique with respect to prior sequences of points and associated noise variances. In other examples, the maximum likelihood estimation may be based on additional feedback provided by predictive noise discriminator 120 based on observed data of prior noise sequences added to other documents. For example, the predictive noise discriminator 120 may provide a statistical distribution of noise variances for each point across a plurality of prior noisy data sets, and the synthetic noise coupler 140 may identify a new noisy data set based on a maximum likelihood the noisy data set has a statistical distance (e.g., Euclidean distance, relative entropy, etc.) from the distribution that is greater than a threshold value.

At step 235, synthetic noise coupler 140 and/or predictive noise discriminator 120 may test the sequence of points and/or the sequence of noise variances to determine their uniqueness based on the observed plurality of noisy data added to other digital documents and based on predictive noise discriminator's pre-training with that observed data. The uniqueness of the sequence may be determined by comparing the sequence of points and variances to the previous noisy data. In some examples, feedback may be based on the overall pattern of noise variances added to the document being unique from noise patterns in other previous documents in which information has been obscured so that knowledge about noise added to one document cannot be used to reveal sensitive data in another document. Determining uniqueness may further be based on the security level of the data, with a higher level of security requiring more distinct noise variances. Moreover, the sequence of points may be individual pixels or may be groups of pixels treated with the same noise variance. The number of pixels having the same noise variance applied may be based on the security level of the data, with more pixels being grouped together as a point for lower levels of security.

In some examples, the sequences of points and/or noise variances across multiple documents may have a Gaussian distribution. In some examples, the values of the points in the document (e.g., the luminance) with the noise variances added across multiple documents may have a Gaussian distribution.

If the synthetic noise coupler 140 and/or predictive noise discriminator 120 determines that the sequence of points and/or noise variances are not unique, the process may return to step 230 to determine a new or modified sequence of points and/or noise variances. Once the uniqueness of the sequence has been confirmed, the process proceeds to step 240, at which the noise addition variance collector 130 records the sequence of additional points and respective additional noise variances as a unique noisy data set in storage. The unique noisy data set may include the noise variances with or without the values of the points added. The predictive noise discriminator 120 may later retrieve the new noisy data set from storage and add it to the plurality of noisy data sets upon which it is trained.

At step 245, synthetic noise coupler 140 adds the new unique noisy data set to the digital document to generate a Gaussian noisy image with sensitive data obscured, for example, shown as image 310 in FIG. 3. The Gaussian noisy image may then be transmitted in step 250 via a network (e.g., an unsecured network), with the sensitive data protected. While process 200 is described as being performed by synthetic noise coupler 140, the process may be performed individually or collectively by any of the computing platforms described herein, such as 110, 120, 130, 140, and/or 150.

FIG. 4 illustrates a process 400 by which unique noise patterns are identified (e.g., by predictive noise discriminator 120) for adding to digital documents for obscuring sensitive data.

At step 405, predictive noise discriminator 120 receives a plurality of noisy data sets. Each noisy data set comprises a sequence of points (e.g., pixels or regions in an image of a digital document) relative to a starting point and a sequence of values corresponding to the sequence of points, respectively. As described above, the sequence of values may be point values (e.g., luminesces), each with a noise variance added, or may be a sequence of noise variances without the point values.

At step 410, predictive noise discriminator 120 may train a model with a plurality of noisy datasets to identify the uniqueness of a test data set. In some examples, the training of the model may determine a distribution of the noise variances for each point across the datasets, and the predictive noise discriminator 120 may determine uniqueness by a statistical distance of the test data set from the plurality of noisy data sets or the distribution of the plurality of noise data sets. For example, the predictive noise discriminator 120 and the synthetic noise coupler 140 may identify the uniqueness of the new noisy data set based on a statistical distance (e.g., Euclidean distance, relative entropy, etc.) of the test data set from the distribution that is greater than a threshold value. In some examples, the model may be a machine learning model (e.g., a neural network) that is trained with the plurality of prior noisy data sets to determine the uniqueness of a test noisy data set.

At step 415, predictive noise discriminator 120 may receive a new noisy data set to be tested, for example, from synthetic noise coupler 140.

At step 420, predictive noise discriminator 120 may test the received new noisy data set with a pre-trained model to determine uniqueness, for example, based on a statistical distance from the plurality of prior noisy data sets. In some examples, predictive noise discriminator 120 may test the received noisy data set against a statistical distribution of the plurality of prior noisy data sets. In some examples, predictive noise discriminator 120 may test the received noisy data set against one or more of the plurality of prior noisy data sets individually.

At step 425, predictive noise discriminator 120 may update the plurality of prior noisy data sets by adding the received noisy data set to the plurality based on the received noisy data having been determined to be unique. The predictive noise discriminator 120 may then re-train the model based on the updated plurality of prior noisy data sets. While process 400 is described as being performed by predictive noise discriminator 120, the process may be performed individually or collectively by any of the computing platforms described herein, such as 110, 120, 130, 140, and/or 150.

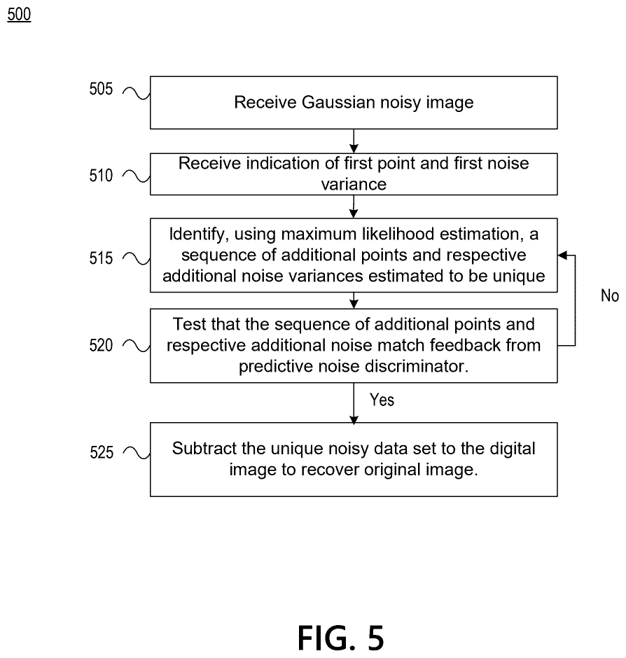

FIG. 5 depicts an illustrative process 500 for removing Gaussian noise variances from a redacted digital document based on maximum likelihood Gaussian noise reversal. For example, Gaussian denoiser 150 may receive a banking document such as a check with noise variances added, as shown by 315 in FIG. 3 from computing platform 110 (e.g., a secure banking server) via a network connection (e.g., an unsecured network).

At step 510, Gaussian denoise 150 may receive an indication of a first point and first noise variance that was originally added to the document. The indication may be received, for example, from predictive noise discriminator 120 or noise addition variance collector 130, which may have retrieved the indication from storage, where it was stored when the first point and the first noise variance were added to the document.

In step 515, Gaussian denoise 150 may attempt to identify, using maximum likelihood estimation, a sequence of additional points and respective additional noise variances estimated to be unique, which could have been added to the digital document. For example, based on the selected starting point and/or starting noise variance for the starting point, Gaussian denoiser 150 may estimate a sequence of points (e.g., pixels or regions of pixels) and a sequence of noise variances (e.g., Gaussian noise variances) estimated to have a maximum likelihood of being unique with respect to prior sequences of points and associated noise variances. For example, step 515 may implement the same algorithm as was implemented in step 230 for originally determining the noise sequence based on the same feedback from predictive noise discriminator 120 based on observed data of prior noise sequences added to other documents. Because the estimation is based on the same starting point, starting noise variance, and/or feedback based on prior observed data, Gaussian denoiser 150 may identify, partially or completely, the same sequence of points and sequence of noise variances as was originally added. For example, the predictive noise discriminator 120 may provide the same or similar statistical distribution of noise variances for each point across a plurality of prior noisy data sets (from prior to redacting the document using process 200), and the Gaussian denoiser 140 may identify the noisy data set that was added based on a maximum likelihood the noisy data set has a statistical distance (e.g., Euclidean distance, relative entropy, etc.) from the distribution that is greater than a threshold value.

In some examples, instead of receiving feedback from predictive noise discriminator 120, Gaussian denoiser 150 may be pre-trained with the plurality of prior noisy data sets in the same manner as predictive noise discriminator 120 as was described with respect to process 400.

In step 520, Gaussian decoupler 150 and/or predictive noise discriminator 120 may test the sequence of points and/or the sequence of noise variances to determine if they match feedback from predictive noise discriminator 120. For example, step 520 may be performed in the same manner as step 235. In some examples, predictive noise discriminator 120 may retrieve the sequence of points and the sequence of noise variances as originally stored in storage by noise addition variance coupler 130 and generate feedback as to the correctness of the data based on the retrieved data.

If the synthetic noise coupler 140 and/or predictive noise discriminator 120 determines that there is not a match, the process may return to step 515 to adjust the noise variances. Once a match has been confirmed, the process proceeds to step 525, at which Gaussian denoiser 150 subtracts the noise variances from the sequence of points to recover the original digital document with the sensitive data no longer obscured, for example, as shown in image 310 in FIG. 3.

While process 500 is described as being performed by Gaussian denoiser 150, the process may be performed individually or collectively by any of the computing platforms described herein, such as 110, 120, 130, 140, and/or 150.

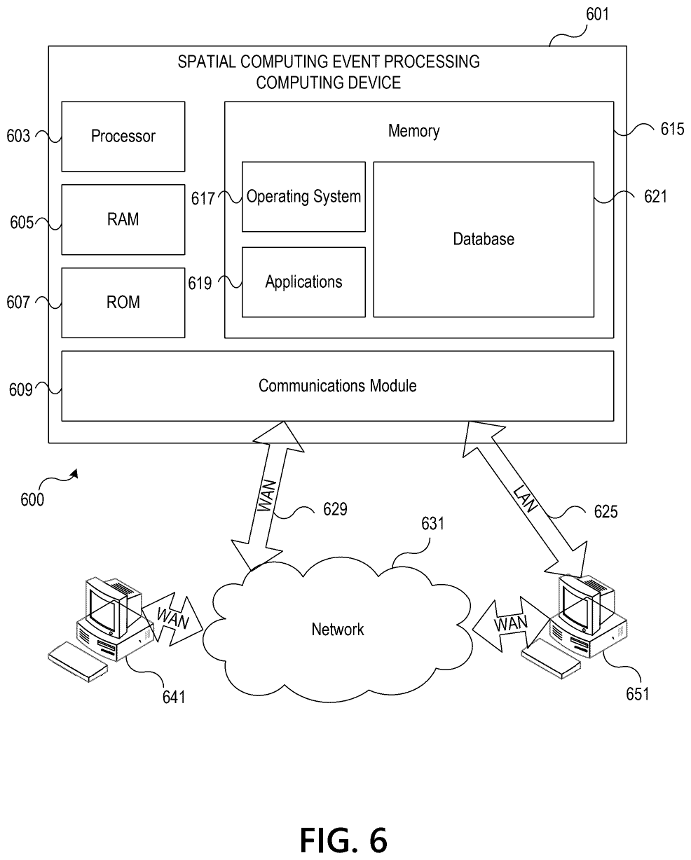

FIG. 6 depicts an illustrative operating environment in which various aspects of the present disclosure may be implemented in accordance with one or more example embodiments. Referring to FIG. 6, computing system environment 600 may be used according to one or more illustrative embodiments. Computing System Environment 600 is only one example of a suitable computing environment. It is not intended to suggest any limitation regarding the scope of use or functionality contained in the disclosure. Computing System Environment 600 should not be interpreted as having any dependency or requirement relating to any one or combination of components shown in illustrative Computing System Environment 600.

Computing system environment 600 may include processor 603 for controlling the overall operation of computing device 601 and its associated components, including Random Access Memory (RAM) 605, Read-Only Memory (ROM) 607, communications module 609, and memory 615. Computing device 601 may include a variety of computer-readable media. Computer-readable media may be any available media that may be accessed by computing device 601, may be non-transitory, and may include volatile and nonvolatile, removable and non-removable media implemented in any method or technology for storage of information such as computer-readable instructions, object code, data structures, program modules, or other data. Examples of computer-readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by computing device 601.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor (e.g., hardware processor) on computing device 601. Such a processor may execute computer-executable instructions stored on a computer-readable medium.

Software may be stored within memory 615 and/or storage to provide instructions to processor 603 for enabling computing device 601 to perform various functions as discussed herein. For example, memory 615 may store software used by computing device 601, such as operating system 617, application programs 619, and associated database 621. Also, some or all of the computer-executable instructions for computing device 601 may be embodied in hardware or firmware. Although not shown, RAM 605 may include one or more applications representing the application data stored in RAM 605 while computing device 601 is on and corresponding software applications (e.g., software tasks) are running on computing device 601.

Communications module 609 may include a microphone, keypad, touch screen, and/or stylus through which a user of computing device 601 may provide input. It may also include one or more speakers for providing audio output and a video display device for providing textual, audiovisual, and/or graphical output. Computing system environment 600 may also include optical scanners (not shown).

Computing device 601 may operate in a networked environment supporting connections to one or more remote computing devices, such as 641 and 651. Computing devices 641 and 651 may be personal computing devices or servers that include any or all of the elements described above relative to computing device 601.

The network connections depicted in FIG. 6 may include Local Area Network (LAN) 625 and Wide Area Network (WAN) 629, as well as other networks. When used in a LAN networking environment, computing device 601 may be connected to LAN 625 through a network interface or adapter in communications module 609. When used in a WAN networking environment, computing device 601 may include a modem in communications module 609 or other means for establishing communications over WAN 629, such as network 631 (e.g., public network, private network, Internet, intranet, and the like). The network connections shown are illustrative, and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP), and the like may be used, and the system can be operated in a client-server configuration to permit a user to retrieve web pages from a web-based server.

Each computing platform 110, 120, 130, 140, and/or 150 may be implemented using the architecture and components of computing device 601. The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smartphones, multiprocessor systems, microprocessor-based systems, set-top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, etc. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to implement one or more aspects of the disclosure more effectively, and such data structures are contemplated to be within the scope of computer-executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events described herein may be transferred between a source and a destination in light or electromagnetic waves traveling through signal-conducting media such as metal wires, optical fibers, or wireless transmission media (e.g., air or space). In general, one or more computer-readable media may be and/or include one or more non-transitory computer-readable media.

As described herein, the various methods and acts may be operative across one or more computing servers and one or more networks. The functionality may be distributed in any manner or may be located in a single computing device (e.g., a server, a client computer, and the like). For example, in alternative embodiments, one or more of the computing platforms discussed above may be combined into a single computing platform, and the single computing platform may perform the various functions of each computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor and a memory storing computer-readable instructions that, when executed by the at least one processor, cause the computing platform to:
receive a digital image;
identify a starting point in the digital image where noise may be added;
generate a starting noise variance corresponding to the starting point;
identify, using maximum likelihood estimation, a new noisy data set estimated to be unique, wherein the new noisy data set comprises a plurality of additional points in the digital image and a plurality of additional noise variances corresponding to the plurality of additional points, respectively, wherein the plurality of additional points are ordered in a sequence relative to the starting point;
add the new noisy data set to the digital image to generate a Gaussian noisy image; and
transmit the Gaussian noisy image via an unsecured network.

2. The computing platform of claim 1, wherein the plurality of additional noise variances has a Gaussian distribution.

3. The computing platform of claim 1, wherein the computer-readable instructions, when executed by the at least one processor, cause the computing platform to:
detect one or more regions in the digital image comprising sensitive data; and
select the plurality of additional points in the digital image from within the one or more regions.

4. The computing platform of claim 1, wherein the computer-readable instructions, when executed by the at least one processor, cause the computing platform to:
receive feedback from a predictive noise model indicating uniqueness, within a plurality of prior noisy data sets, of the starting point and the starting noise variance, wherein the identifying of the starting point and the generating of the starting noise variance is based on the feedback.

5. The computing platform of claim 1, wherein the computer-readable instructions, when executed by the at least one processor, cause the computing platform to:
test the new noisy data set against a plurality of prior noisy data sets; and
verify, based on the testing, that the new noisy data set is unique amongst the plurality of prior noisy data sets, wherein the adding of the new noisy data set to the digital image is based on the verifying.

6. The computing platform of claim 5, wherein to the computer-readable instructions, when executed by the at least one processor, cause the computing platform to:
calculate a statistical distance between the new noisy data set and the plurality of prior noisy data sets, wherein the verifying that the new noisy data set is unique is based on the statistical distance being greater than a predetermined threshold.

7. The computing platform of claim 5, wherein the computer-readable instructions, when executed by the at least one processor, cause the computing platform to:
store, based on the verifying, the new noisy data set in a database as one of the plurality of prior noisy data sets.

8. The computing platform of claim 5, wherein, for each additional data point of the plurality of additional points, the plurality of prior noisy data sets comprises a plurality of noise variances having a Gaussian distribution, wherein each noise variance of the plurality of noise variances is comprised in a different one of the plurality of prior noisy data sets.

9. The computing platform of claim 5, wherein to test the new noisy data set against the plurality of prior noisy data sets, the computer-readable instructions, when executed by the at least one processor, cause the computing platform to:
evaluate the new noisy data set with a machine-learning model trained with the plurality of prior noisy data sets.

10. A method, comprising:
receiving, by a computer platform, a digital image;
identifying a starting point in the digital image where noise may be added;
generating a starting noise variance corresponding to the starting point;
identifying, using maximum likelihood estimation, a new noisy data set estimated to be unique, wherein the new noisy data set comprises a plurality of additional points in the digital image and a plurality of additional noise variances corresponding to the plurality of additional points, respectively, wherein the plurality of additional points are ordered in a sequence relative to the starting point;
adding the new noisy data set to the digital image to generate a Gaussian noisy image; and
transmitting, from the computer platform, the Gaussian noisy image via an unsecured network.

11. The method of claim 10, wherein the plurality of additional noise variances has a Gaussian distribution.

12. The method of claim 10, further comprising:
detecting one or more regions in the digital image comprising sensitive data; and
selecting the plurality of additional points in the digital image from within the one or more regions.

13. The method of claim 10, further comprising:
receiving feedback from a predictive noise model indicating uniqueness, within a plurality of prior noisy data sets, of the starting point and the starting noise variance, wherein the identifying of the starting point and the generating of the starting noise variance is based on the feedback.

14. The method of claim 10, further comprising:
testing the new noisy data set against a plurality of prior noisy data sets; and
verifying, based on the testing, that the new noisy data set is unique amongst the plurality of prior noisy data sets, wherein the adding of the new noisy data set to the digital image is based on the verifying.

15. The method of claim 14, further comprising:
calculating a statistical distance between the new noisy data set and the plurality of prior noisy data sets, wherein the verifying that the new noisy data set is unique is based on the statistical distance being greater than a predetermined threshold.

16. The method of claim 14, wherein, for each additional data point of the plurality of additional points, the plurality of prior noisy data sets comprises a plurality of noise variances having a Gaussian distribution, wherein each noise variance of the plurality of noise variances is comprised in a different one of the plurality of prior noisy data sets.

17. The method of claim 14, wherein, to test the new noisy data set against the plurality of prior noisy data sets, the method comprises:
evaluating the new noisy data set with a machine-learning model trained with the plurality of prior noisy data sets.

18. One or more non-transitory computer-readable media storing instructions that, when executed by a computing platform comprising at least one processor, memory, and a communication interface, cause the computing platform to:
receive a digital image;
detect one or more regions in the digital image comprising sensitive data; and
identify a starting point in the one or more regions where noise may be added;
generate a starting noise variance corresponding to the starting point;
identify, using maximum likelihood estimation, a new noisy data set estimated to be unique, wherein the new noisy data set comprises a plurality of additional points in the one or more regions and a plurality of additional noise variances corresponding to the plurality of additional points, respectively, wherein the plurality of additional points are ordered in a sequence relative to the starting point, and wherein the plurality of additional noise variances has a Gaussian distribution;
add the new noisy data set to the digital image to generate a Gaussian noisy image; and
transmit the Gaussian noisy image via an unsecured network.

19. The one or more non-transitory computer-readable media of claim 18, wherein the instructions, when executed by the computing platform, cause the computing platform to:
receive feedback from a predictive noise model indicating uniqueness, within a plurality of prior noisy data sets, of the starting point and the starting noise variance, wherein the identifying of the starting point and the generating of the starting noise variance is based on the feedback.

20. The one or more non-transitory computer-readable media of claim 18, wherein the instructions, when executed by the computing platform, cause the computing platform to:
test the new noisy data set against a plurality of prior noisy data sets; and
verify, based on the testing, that the new noisy data set is unique amongst the plurality of prior noisy data sets, wherein the adding of the new noisy data set to the digital image is based on the verifying.
